(19) United States
(12) Patent Application Publication
(10) Pub. No.: US 2008/0110867 A1
(43) Pub. Date: May 15, 2008

(54) Stud retaining weld head

(76) Inventors: Jon J. Leininger, Wilson, NY (US); Bob Bonham, Oakville (CA)

Correspondence Address: SIM & MCBURNEY, 330 UNIVERSITY AVENUE, 6TH FLOOR, TORONTO, ON, M5G 1R7, omitted

(21) Appl. No.: 11/826,084

(22) Filed: Jul. 12, 2007

Related U.S. Application Data
(60) Provisional application No. 60/830,088, filed on Jul. 12, 2006.

(51) Int. Cl. B23K 9/20

(52) U.S. Cl. 219/98; 219/119

(57) ABSTRACT

A stud weld head includes an electrode with a base for attaching the electrode to the stud welder; a body extending from the base and having a stud receiving cavity; and a retention device associated with the stud receiving cavity to permit entry and removal of a stud from the cavity without contact with the retention device. The improved stud weld head retains the stud during the welding operation reducing the chances that the stud inconveniently falls out of the stud receiving cavity.

### REFERENCE TO RELATED APPLICATION

This application claims priority under 35 U.S.C. 119(e) from U.S. Provisional Patent Application No. 60/830,088 filed Jul. 12, 2006.

### FIELD OF THE INVENTION

The methods and systems disclosed herein relate generally to stud welders and more particular to a weld head for temporarily retaining a stud in a stud welder gun.

### BACKGROUND OF THE INVENTION

Stud welder electrodes for stud guns typically comprise a base for attaching the electrode to the stud welder; and a body extending from the base. The body has a stud receiving cavity dimensioned to slidably receive the shaft of a stud, such as a dent-pulling stud. The stud is typically received in a consumable stud weld tip which is, in turn, received by the stud receiving cavity.

A trim rivet attachment, or rivet tip, may be received by a primary electrode of a stud welding gun and accommodate the dimensions of trim rivets thereby to facilitate Him rivet welding. The stud weld tip is removed from the electrode and replaced with the rivet weld tip. It is known to attach a magnet to an end of a rivet weld tip to attract a ferrous trim rivet so that during trim welding the small rivet does not fall out of the rivet weld tip just prior to being welded to an object.

The rivet weld tip is dimensioned to receive the broad head of a ferrous rivet in a cavity thereof, with the short shaft of the rivet extending out of the rivet weld tip a sufficient distance to contact an object to which it is to be welded. At the bottom of the cavity the magnet is positioned to face and attract the broad head of the rivet and retain it within the cavity until welding is, completed. The magnet at one end of the rivet weld tip attracts the rivet through a segment of copper in the body of the rivet weld tip that opens to the flat bottom cavity. Neither the rivet holder nor the electrode has contact surfaces directly between magnet and the part being welded. In this configuration, the rivet offers a discrete flat surface for attraction to the magnet, and the magnet therefore does not need to be very powerful in order to temporarily retain the rivet.

Studs are typically larger and heavier than rivets, and have narrower cylindrical shafts. Studs are placed within the stud receiving cavity such that, as opposed to a trim rivet, the broader head of the stud remains external to the electrode to be the point of contact with the object to which the stud is to be welded. There is therefore no broad surface on an end of the stud within the electrode that can be conveniently used as a point of attraction with a magnet for effective localized retention. As such, a stronger magnetic field is required. Furthermore, it has been found that magnets that contact a stud are easily damaged due to the high currents passing through the studs.

Repairing dents in automobile panels is time consuming work and welding studs into a damaged panel is only the first in a lineup of many operations. Studs tend to fall out of a welder when the front of the gu is pointed downward in the steps just prior to welding. Much time can be wasted scrounging around on the garage floor for dropped weld studs.

It is an object of an aspect of the following to provide a novel device that obviates or mitigates the disadvantages of prior art devices.

### SUMMARY OF THE INVENTION

According to one aspect there is provided an electrode for a stud welder comprising:

a base for attaching the electrode to the stud welder;

a body extending from the base and having a stud receiving cavity;

a retention device associated with the stud receiving cavity to permit entry and removal of a stud from the cavity without contact with the retention device.

When used in stud welding, the improved electrode reduces the chances that a stud will slide out of the electrode when the weld gun is inadvertently pointed downward after insertion of die stud. The device therefore becomes easier to use and the time consumption and operator frustration common to prior art devices is avoided. The retention device being out of contact with the stud also sustains the life of the retention device.

According to another aspect, there is provided an insulated weld head for a stud gun comprising:

a generally cylindrical body made of an electrically insulating material, the body having a bore therethrough, the bore having a cavity at a distal end thereof that is dimensioned to receive a cylindrical sleeve magnet;

wherein a primary electrode of the stud gun is received in both the bore and the cylindrical sleeve magnet, the cylindrical sleeve magnet positioned along the electrode to temporarily retain a stud within a stud receiving cavity of the electrode.

According to yet another aspect, there is provided a weld head for a stud gun comprising:

a generally cylindrical body made of an electrically insulating material, the body having a bore therethrough for receiving a primary electrode and an outer cavity for receiving a ground ring;

a cylindrical sleeve retention magnet encapsulated in an electrically insulating material received in space between the inner dimension of the ground ring and the electrode, wherein the primary electrode is received by the cylindrical sleeve magnet, the cylindrical sleeve magnet positioned along the electrode to temporarily retain a stud within a stud receiving cavity of the electrode.

### BRIEF DESCRIPTION OF THE FIGURES

Embodiments will now be described more fully with reference to the accompanying drawings, in which:

FIG. 1 is a side view of a known stud welder;

FIG. 2 is a cross-sectional cutaway view of a known primary electrode with inserted stud;

FIG. 3 is a front perspective view of a known rivet tip and rivet;

FIG. 4 is a rear perspective view of the known rivet tip of FIG. 3 with magnet and rivet;

FIG. 5 is a cross-sectional cutaway view of a primary electrode with a retention magnet adjacent the stud cavity according to one embodiment of the invention;

FIG. 6 is an exploded elevational view showing the inter-relationship of the components of the electrode of FIG. 5 and a stud;

FIG. 7 is an isolated view of an adaptor for extending the length of the primary electrode, according to an embodiment of the invention;

FIG. 8 is an exploded elevational view showing the inter-relationship of the components of the electrode of FIG. 5 with the adaptor of FIG. 7;

FIG. 9 is a cross-sectional cutaway view of a primary electrode with a cylindrical sleeve retention magnet in the stud cavity according to another embodiment of the invention;

FIG. 10 is a cross-sectional cutaway view of a primary electrode and extension adaptor each with cylindrical sleeve retention magnets in respective stud cavities thereof;

FIG. 11 is side and front views of a cylindrical sleeve retention magnet;

FIG. 12 is a schematic diagram of an electromagnetic retention circuit according to one embodiment;

FIG. 13 shows side and side cutaway views of a novel insulating weld head having a cavity for a cylindrical sleeve retention magnet, according to another embodiment;

FIG. 14 shows side cutaway views of a novel ground ring having a cavity for a cylindrical sleeve retention magnet, according to another embodiment; and

FIG. 15 shows a side cutaway view of a novel insulating weld head having a cavity for an electromagnetic retention coil, according to another embodiment.

### DETAILED DESCRIPTION OF THE EMBODIMENTS

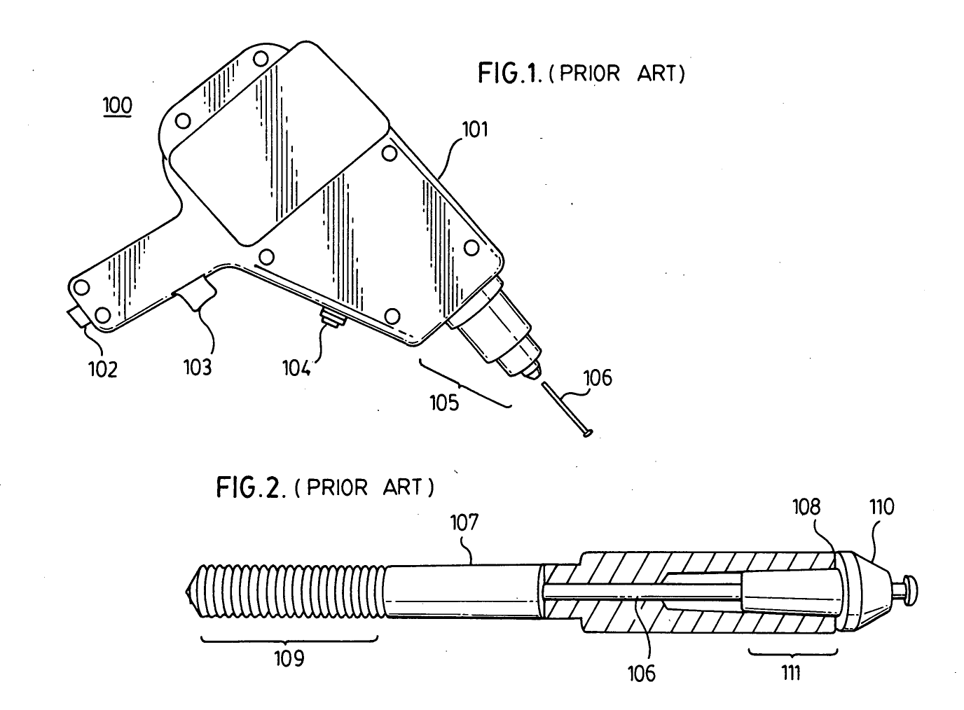

FIG. 1 is a photograph of a known stud welder 100, or stud gun, manufactured by H&S Autoshot of Georgetown, Ontario, Canada Stud welder 100 includes a housing 101, an electrical cord 102, a switch 103, a fuse 104, and a stud weld head 105. A stud 106 of ferrous material is received by stud weld head 105 prior to and during a welding operation. Stud weld head 105 comprises a primary electrode 107 for delivering high weld current to a stud 106 for welding stud 106 to sheet metal of automobile panels during body work for dent-pulling repairs.

FIG. 2 is a cross-sectional cutaway photograph of known copper primary electrode 107. Primary electrode 107 includes a stud receiving cavity with a tapered opening 108 at its working end, and a threaded region for fastening current carrying conductor 109. A consumable stud weld tip 110 has a taper 111 that connectedly mates with tapered opening 108 of electrode 107. Stud 106 is shown as received by the stud receiving cavity.

FIG. 3 is a front perspective view of a known rivet tip and rivet. A tapered portion of the rivet tip is dimensioned to be received by tapered opening 108 of stud receiving cavity in a similar manner to consumable stud weld tip 110. The broad head of the rivet is received by a rivet cavity in the rivet tip.

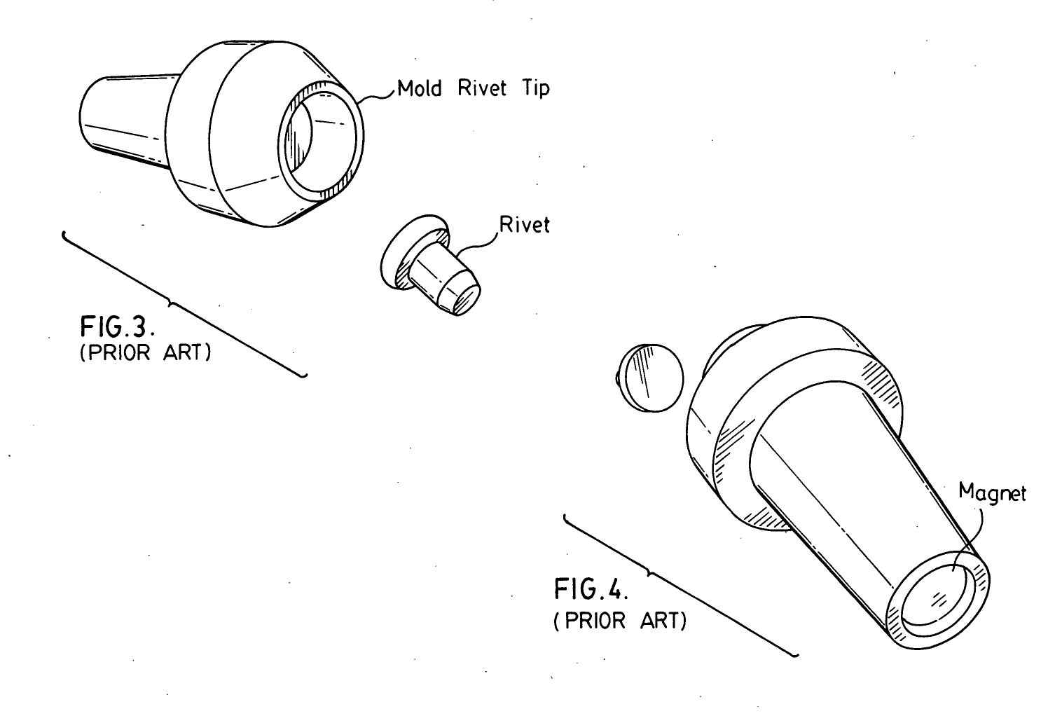

FIG. 4 is a rear perspective view of the known rivet tip of FIG. 3 with magnet and rivet. The magnet is positioned within the rivet tip to attract the broad head of the rivet and retain the rivet prior to and during the welding operation.

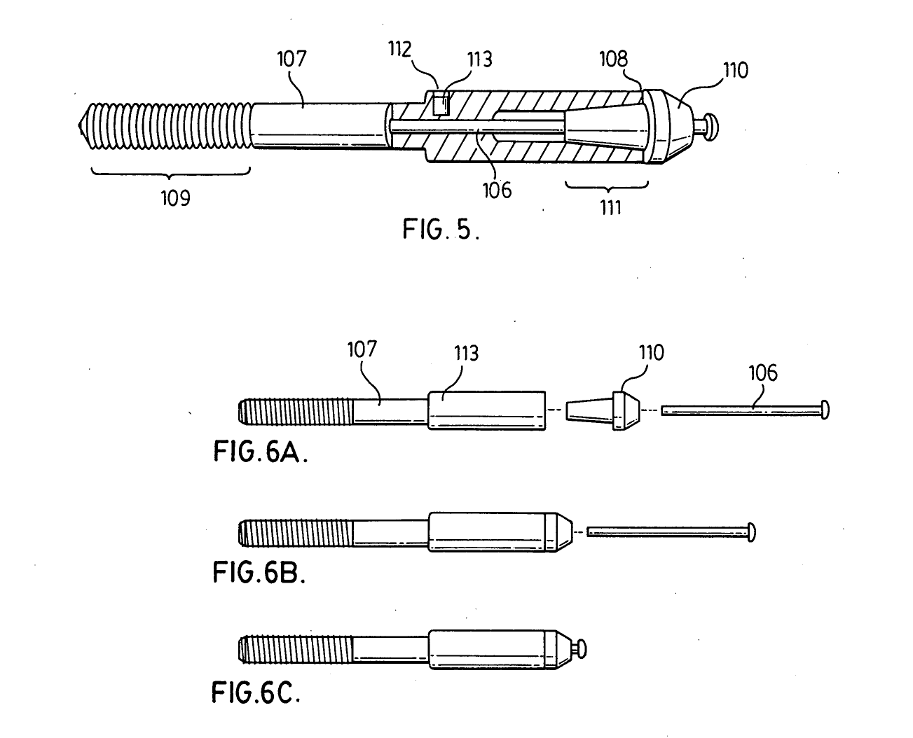

FIG. 5 is a cross-sectional cutaway photograph of a primary electrode 107 with a retention magnet 113 adjacent the stud receiving cavity according to one embodiment of the invention. In order to position retention magnet 113, an opening 112 is drilled into the body of the electrode 107 adjacent the stud receiving cavity. It has been found that a hole of approximately ⅛^{th} inches in diameter and of a depth just shy of the stud receiving cavity for receipt of the retention magnet 113 is sufficient. The retention magnet does not extend into the stud receiving cavity and therefore does not physically contact stud 106, when stud 106 is received in the stud receiving cavity.

Retention magnet 113 is cylindrically shaped, and is preferably formed of heat-resistant Samarium Cobalt in order to withstand the heat typically generated at the electrode during constant use of the stud welder. Other magnetic materials, such as neodymium, may be used. Beneficially, cylindrically-shaped retention magnets 113 of various materials are available off-the-shelf from many suppliers.

FIG. 6 is an exploded elevational photograph showing the inter-relationship of the components of the electrode 107 of FIG. 5 and a stud 106.

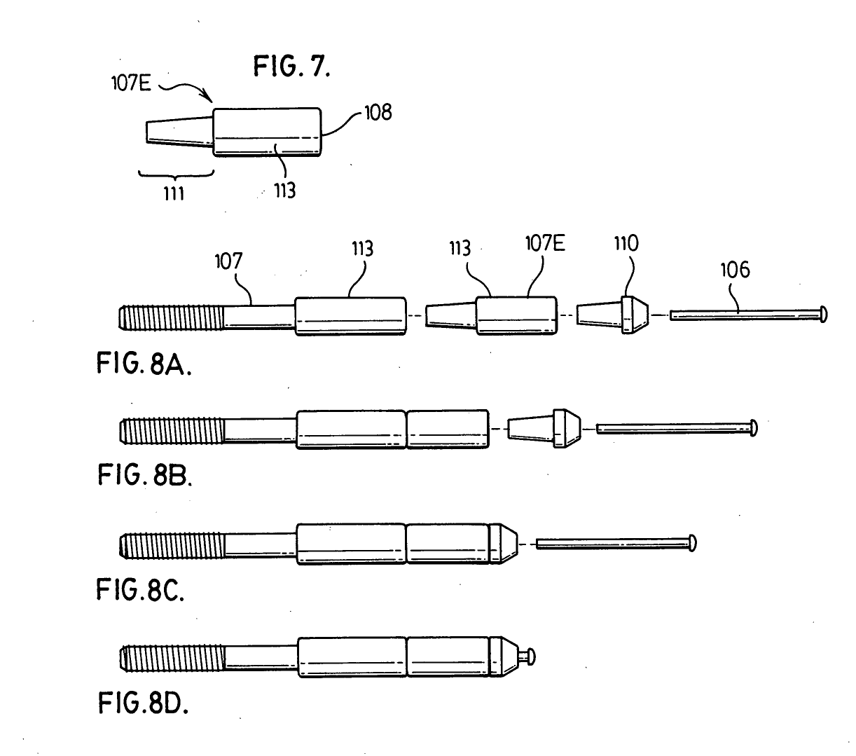

FIG. 7 is a photograph of an adaptor electrode, or extension, 107E for extending the length of the primary electrode, according to an embodiment of the invention. Extension 107E is a separate piece generally of the same configuration as the body of electrode 107, except that it has a taper 111 that connectedly mates with tapered opening 108 of electrode 107. A magnet 113 is embedded in adapter electrode 107E in the same manner as that shown embedded in electrode 107 in FIGS. 5 and 6.

FIG. 8 is an exploded elevational photograph showing the inter-relationship of the components of the electrode of FIG. 5 with the adaptor electrode/extension of FIG. 7. It can be seen that retention magnets 113 are respectively received by both electrode 107 and extension 107E.

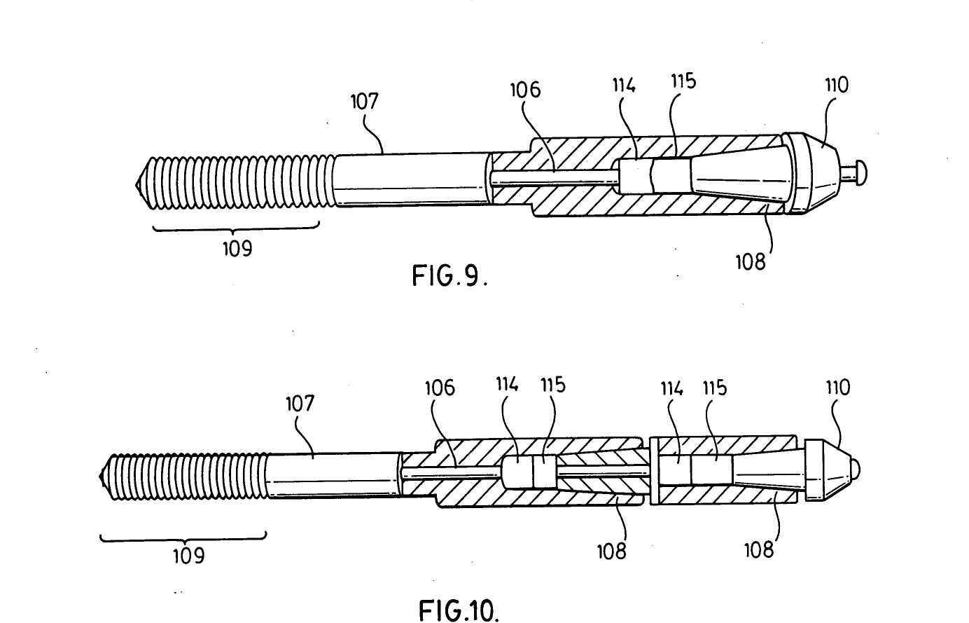

FIG. 9 is a cross-sectional cutaway photograph of a primary electrode 107 with a cylindrical sleeve or ring shaped retention magnet 114 in the stud cavity according to an alternative embodiment of the invention. Sleeve magnet 114 is generally more expensive to provide than is the small cylinder magnet 113 of the FIG. 5 embodiment, particularly due to the tooling required. However, the tooling of the electrode itself is not in this case required, since it is the stud receiving cavity that receives the ring shaped magnet 114.

FIG. 10 is a cross-sectional cutaway view of a primary electrode 107 and extension adaptor 107E each with cylindrical sleeve retention magnets 114 in respective stud cavities thereof.

FIG. 11 is side and front views of the cylindrical retention magnet 114 for the embodiment of FIG. 9. The dimensions in FIG. 11 are provided for illustrative purposes only. As such, the dimensions of retention magnet 114 should be understood to facilitate reception of a ferrous stud 106 without contact and reception by and within a stud receiving, cavity of an electrode such as electrode 107 (or adaptor 107E). The particular retention magnet 114 shown in FIG. 11 has an inner diameter of about 0.125 inches and an outer diameter of about 0.251 inches. Preferably, retention magnet 114 has a 20° taper to widen the stud-facing opening. However, the inner diameter of retention magnet 114 should be such that stud 106 is easily received such that stud 106 does not contact retention magnet 114 when properly seated in the stud receiving cavity for the welding operation. A rounded rear edge having a radius of approximately 0.031 inches eases insertion of retention magnet 114 into the stud receiving cavity.

According to a further embodiment, the retention device is an electromagnet, rather than a permanent magnet. A permanent magnet in an electrode might attract unwanted foreign iron particles and over time require additional maintenance of the stud gun. A benefit to having an electromagnetic field in this application is the inherent control over magnetic attraction, since the electromagnetic field decays over time after use. A stud gun employing such a retention device would therefore be easier to maintain than one employing a permanent magnet.

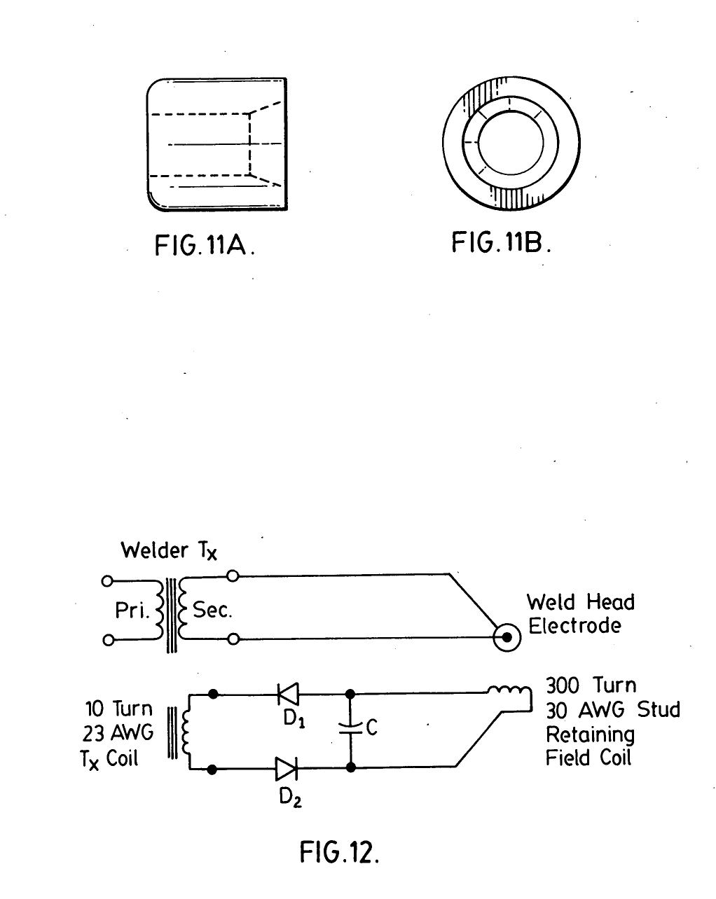

FIG. 12 is a schematic diagram of an electromagnetic retention circuit according to one embodiment. The circuit is similar to a relay control, and can be integrated into a 0.125 inch diameter by 0.8 inch length increase in the 0.5 inch diameter bore of the fiber head surrounding the electrode in a stud gun such as that shown FIG. 1. A stud retaining magnetic field is generated within the stud receiving cavity by a small holding capacitor C linked to a 300 turn, 30 AWG field coil. The field coil retention circuit is powered by but electrically isolated from the main weld circuit (shown above it) by using just ten (10) turns of insulated magnet wire wrapped around one wing of the main transformer (designated Tx). The input power is rectified by diodes D in order to charge the 3-5 volt capacitor C having sufficient Farad value to provide at least a one-minute time period for sustaining power to the field coil to thereby provide stud retention between welds. Yield from the ten turns of conductor is about 30 watts of power using 23 gauge conductor. However, depending on wire size chosen during implementation there may be a resistor or switching (cut off) component required (not shown in FIG. 12).

The stud retaining circuit shown in FIG. 12 does not interfere with welding, and maintains a stud-retaining magnetic field around the electrode of the stud welder without physically contacting the electrode. Holding capacitor C and the field coil is energized for a time constant of a few minutes whenever the gun is triggered, such as just prior to a welding operation. The circuit of FIG. 12 can maintain a stud-retaining magnetic field around the electrode of a stud welder such as that shown in FIG. 1 without physically contacting the electrode. Benefically, machine modifications to the electrode itself are not required.

Similar to a relay control, the circuit shown in FIG. 12 offers a fast turn-on/delayed-off characteristic. This dimension allows the positioning of the field coil concentrically within the enlarged portion of the bore of the insulating fiber head of the stud welder having the electrode running through its center.

When activated, a weld stud 106 is firmly retained in the electrode until the electrical power dissipates. Alternative embodiments of the electromagnetic stud retention circuit may be contemplated by the ordinary skilled worker on the basis of the above and are believed to be within the scope of the invention.

The input stage of an electromagnetic retention circuit could form the basis for a broader DC (direct current) electronic package being powered by AC (alternating current) transformer induction, to provide one or more complementary retention functions such as refined electronic stud retention control. One such function, for example, may include pulsed attraction, enabling the field coil to remain cooler throughout operation. To support such a circuit, rectifier diodes D1 and D2 in FIG. 12 would be replaced by a single fil-wave-bnrdge for rectifying the AC power, as would be understood by the skilled worker. Further conditioning of input power to a circuit designed to attain the overall objective, in combination with any other desired features, may be required.

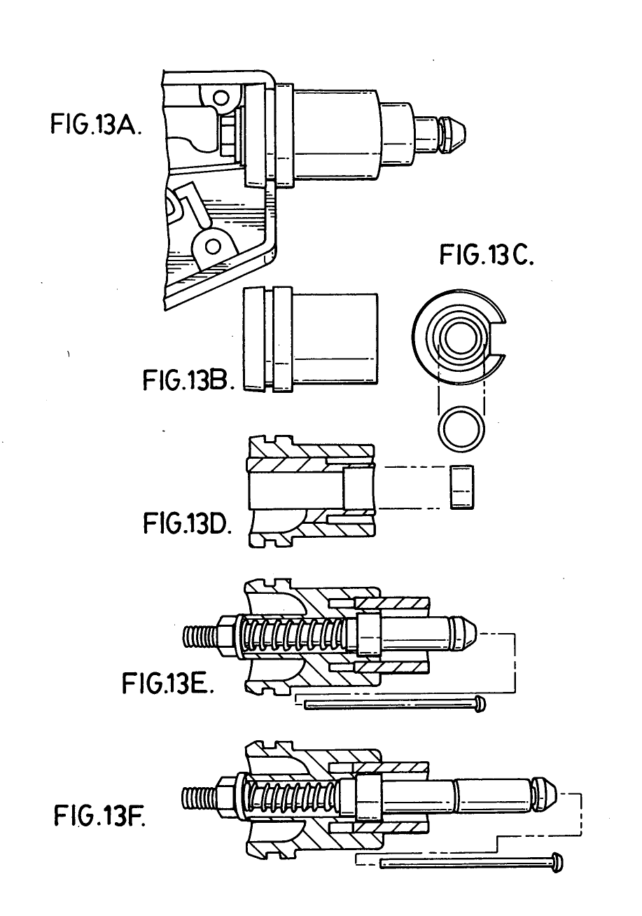

FIG. 13 shows side and side cutaway views of a novel insulating weld head having a cavity for a cylindrical sleeve retention magnet, according to another embodiment. The cylindrical sleeve retention magnet retains studs within the electrode. The cylindrical sleeve retention magnet is external to and receives a standard electrode. As such, no modifications to an electrode are required.

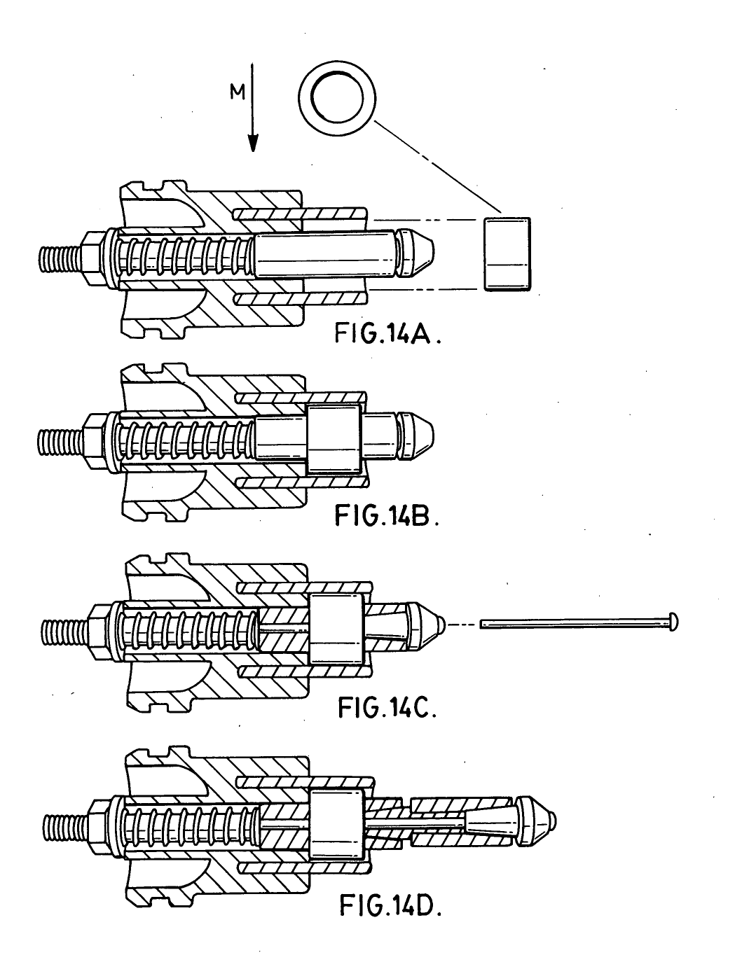

FIG. 14 shows side cutaway views of a novel configuration involving a stud head ground ring that receives a cylindrical sleeve retention magnet, according to another embodiment. The inner wall of the ground ring accommodates the dimensions of the retention magnet. According to this embodiment, neither the insulated weld head, the electrode or the ground ring require modification. The cylindrical sleeve retention magnet is positioned generally at the end of the insulated weld head between the electrode and the modified ground ring, and receives the electrode. The clearance between the ground ring and the electrode leaves an inherent space therebetween that is taken advantage of for placement of the cylindrical sleeve retention magnet. The cylindrical sleeve retention magnet is nonconductive rubber or ceramic material and can easily be retrofit into existing stud welders.

The cylindrical sleeve retention magnet is encapsulated in rubber if conductive material such as Alnico or nickel iron is used in its construction. However, if the magnetic material to be used is nonconductive, such as a bulk magnetic rubber or ceramic, there is no need for a high temperature plastic, rubber or ceramic boundary.

Due to relatively weak initial field strength, the rubber and ceramic bulk magnetic materials available within the last 10 years or so may not be as suitable for this application; coupled with flier expected attenuation caused by heat. On the other hand, new magnetic material matrixes that have isotropic orientation of rare earth particles suspended in nonconductive high temperature resistant flexible material may technically qualify as an “encapsulated” nonconductive magnet.

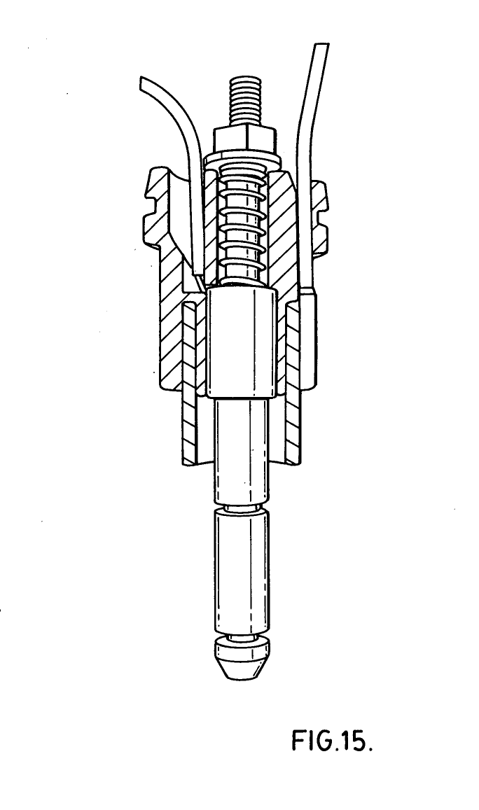

FIG. 15 shows a side cutaway view of a novel insulating weld bead having a cavity for an electromagnetic retention coil, according to another embodiment. The modified insulating weld head in this embodiment has a cavity that is similar to that shown in FIG. 13, but dimensioned to receive the coil instead of the cylindrical sleeve retention magnet. The insulating weld head may be manufactured to be capable of receiving either a coil or a cylindrical sleeve retention magnet, in order to simplify manufacture of the insulating weld head for different stud retention offerings on different tool models. The coil is external to and receives a standard electrode. As such, no modifications to the electrode are required. The coil is energized directly from the stud welder transformer with either AC or rectified DC.

Although embodiments have been described, those of skill in the art will appreciate that variations and modifications may be made without departing from the spirit and scope of the invention defined by the appended claims.

What is claimed is:

1. An electrode for a stud welder comprising:
a base for attaching the electrode to the stud welder;
a body extending from the base and having a stud receiving cavity,
a retention device associated with the stud receiving cavity to permit entry and removal of a stud from the cavity without contact with the retention device.

2. The electrode of claim 1, wherein the retention device comprises a permanent magnet.

3. The electrode of claim 2, wherein the permanent magnet is within the body adjacent the stud receiving cavity.

4. The electrode of claim 3, wherein the permanent magnet is cylinder-shaped.

5. The electrode of claim 2, wherein the permanent magnet is within the stud receiving cavity.

6. The electrode of claim 5, wherein the permanent magnet is a cylindrical sleeve magnet dimensioned to receive an end of the stud without contact.

7. The electrode of claim 6, wherein the cylindrical sleeve magnet has a tapered opening.

8. The electrode of claim 2, wherein the permanent magnet is made of one of neodymium and cobalt.

9. The electrode of claim 1, wherein the stud receiving cavity is dimensioned to removably receive a stud weld tip.

10. The electrode of claim 1, wherein the stud receiving cavity is dimensioned to removably receive an adaptor for extending the electrode length.

11. The electrode of claim 2, wherein stud receiving cavity is dimensioned to receive an electrode extender for receiving a stud, the electrode extender having the permanent magnet therein.

12. The electrode of claim 1, wherein the retention device comprises an electromagnet.

13. An apparatus for a stud welder, comprising:
an induction coil associated with a transformer of the stud welder;
a circuit receiving current from the induction coil to perform at least one function complementary to the stud welder.

14. The apparatus of claim 13, wherein the induction coil encircles laminations of the transformer.

15. The apparatus of claim 14, wherein the circuit comprises a field coil positioned proximate a primary electrode of the stud welder for temporarily retaining a stud within the primary electrode.

16. The apparatus of claim 14, wherein the circuit comprises a rectifier for converting alternating current received from the induction coil to direct current.

17. All insulated weld head for a stud gun comprising:
a generally cylindrical body made of an electrically insulating material, the body having a bore therethrough, the bore having a cavity at a distal end thereof that is dimensioned to receive a cylindrical sleeve magnet;
wherein a primary electrode of the stud gun is received in both the bore and the cylindrical sleeve magnet, the cylindrical sleeve magnet positioned along the electrode to temporarily retain a stud within a stud receiving cavity of the electrode.

18. A weld head for a stud gun comprising:
a generally cylindrical body made of an electrically insulating material, the body having a bore therethrough for receiving a primary electrode and an outer cavity for receiving a ground ring;
a cylindrical sleeve retention magnet encapsulated in an electrically insulating material received in space between the inner dimension of the ground ring and the electrode, wherein the primary electrode is received by the cylindrical sleeve magnet, the cylindrical sleeve magnet positioned along the electrode to temporarily retain a stud within a stud receiving cavity of the electrode.
